(19) United States
(12) Patent Application Publication
(10) Pub. No.: US 2006/0264176 A1
(43) Pub. Date: Nov. 23, 2006

(54) Audio I/O device with Bluetooth module

(76) Inventor: Chu-Chai Hong, Hsin Tien (TW)

Correspondence Address: BRUCE H. TROXELL, SUITE 1404, 5205 LEESBURG PIKE, FALLS CHURCH, VA, 22041, US

(21) Appl. No.: 11/258,017

(22) Filed: Oct. 26, 2005

(30) Foreign Application Priority Data
May 17, 2005 (TW) 094207948

(51) Int. Cl. H04B 7/00

(52) U.S. Cl. 455/41.2

(57) ABSTRACT

An audio I/O device with a Bluetooth module, comprising: a Bluetooth module, connected to an audio I/O port so as to receive audio signals from an external microphone through a microphone amplification circuit and transmit/receive wireless audio signals according to wireless Bluetooth protocol; an audio signal processing device, processing the audio signals from the external microphone through the microphone amplification circuit and the wireless audio signals from an electronic product with the wireless Bluetooth protocol; an automatic signal switching device, receiving the audio signals from the external microphone through the microphone amplification circuit and the wireless audio signals from the electronic product with the wireless Bluetooth protocol; a manual signal switching device, switching off the audio signals and the wireless audio signals from the audio signal processing device through the automatic signal switching device while switching on audio signals from an audio I/P port connected to the manual signal switching device so as to output through the audio I/O port when the audio I/O device runs out of electricity; an audio I/O port, connected to an audio output device for audio output and the external microphone for audio input; a microphone amplification circuit, receiving the audio signals from the external microphone and connected to the Bluetooth module and the audio signal processing device for full duplex processing as to output to the electronic product; and an audio input port, receiving analog audio signals from an audio signal generating device so as to output to the audio output device through the audio I/O port; wherein the audio signal generating device, the audio output device and the audio I/O device are connected to the electronic product wirelessly.

### BACKGROUND OF THE INVENTION

1. Field of the Invention

The present invention generally relates to an audio I/O device with a Bluetooth module and, more particularly, to an audio I/O device characterized in that a user can not only receive phone calls from a mobile phone with a Bluetooth module but also listen to music from audio devices such MP3 players, CD players, etc. using the audio I/O device. On the other hand, the user can achieve a plurality of purposes such as joining conferences, giving speeches and interviews through the audio I/O device by connecting an audio input port to a microphone.

2. Description of the Prior Art

Cars have become an inevitable vehicle and mobile phones are used by everyone in the modern day life. However, speaking through mobile phones during driving is a very dangerous thing and may lead to fatal car accidents. Therefore, in many countries, it is forbidden to use a hand-held device during driving unless the hand-held device is installed in the car and is connected to a hand-free module. Nevertheless, conventional hand-free module is wired and is thus not convenient for drivers to focus on driving.

Nowadays, the car-use hands-free module has been incorporated with wireless communication technology, especially Bluetooth-based transmitting and receiving units. With the price of Bluetooth-based chips getting lowered, more and more Bluetooth-based mobile phones are presented and wildly adopted.

Moreover, VoIP is getting popular and many people wear wired earphones and microphones connected to the computer or electronic products connected to the Internet so that they can share the music on the Internet or even speak through MSN and SKYPE. However, it is inconvenient for the user using wired earphones and microphones, and thus the present invention is devoted to Bluetooth-based wireless communication so as to overcome the inconvenience.

Therefore, there is need in providing an audio I/O device with a Bluetooth module so that the user can not only receive phone calls from a mobile phone with a Bluetooth module but also listen to music from audio devices such MP3 players, CD players, etc. using the audio I/O device.

### SUMMARY OF THE INVENTION

It is the primary object of the present invention to provide an audio I/O device with a Bluetooth module, characterized in that a user can not only receive phone calls from a mobile phone with a Bluetooth module but also listen to music from audio devices such MP3 players, CD players, etc. using the audio I/O device.

It is another object of the present invention to provide an audio I/O device with a Bluetooth module, characterized in that the user can achieve a plurality of purposes such as joining conferences, giving speeches and interviews through the audio I/O device by connecting an audio input port to a microphone.

In order to achieve the foregoing objects, the present invention provides an audio I/O device with a Bluetooth module, comprising: a Bluetooth module, connected to an audio I/O port so as to receive audio signals from an external microphone through a microphone amplification circuit and transmit/receive wireless audio signals according to wireless Bluetooth protocol; an audio signal processing device, processing the audio signals from the external microphone through the microphone amplification circuit and the wireless audio signals from an electronic product with the wireless Bluetooth protocol; an automatic signal switching device, receiving the audio signals from the external microphone through the microphone amplification circuit and the wireless audio signals from the electronic product with the wireless Bluetooth protocol; a manual signal switching device, switching off the audio signals and the wireless audio signals from the audio signal processing device through the automatic signal switching device while switching on audio signals from an audio I/P port connected to the manual signal switching device so as to output through the audio I/O port when the audio I/O device runs out of electricity; an audio I/O port, connected to an audio output device for audio output and the external microphone for audio input; a microphone amplification circuit, receiving the audio signals from the external microphone and connected to the Bluetooth module and the audio signal processing device for full duplex processing as to output to the electronic product; and an audio input port, receiving analog audio signals from an audio signal generating device so as to output to the audio output device through the audio I/O port; wherein the audio signal generating device, the audio output device and the audio I/O device are connected to the electronic product wirelessly.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms.

### BRIEF DESCRIPTION OF THE DRAWINGS

The objects, spirits and advantages of the preferred embodiment of the present invention will be readily understood by the accompanying drawings and detailed descriptions:

FIG. 1 is a functional block diagram showing an audio I/O device with a Bluetooth module according to the present invention.

### DETAILED DESCRIPTION OF THE INVENTION

The present invention providing an audio I/O device with a Bluetooth module can be exemplified by the preferred embodiment as described hereinafter.

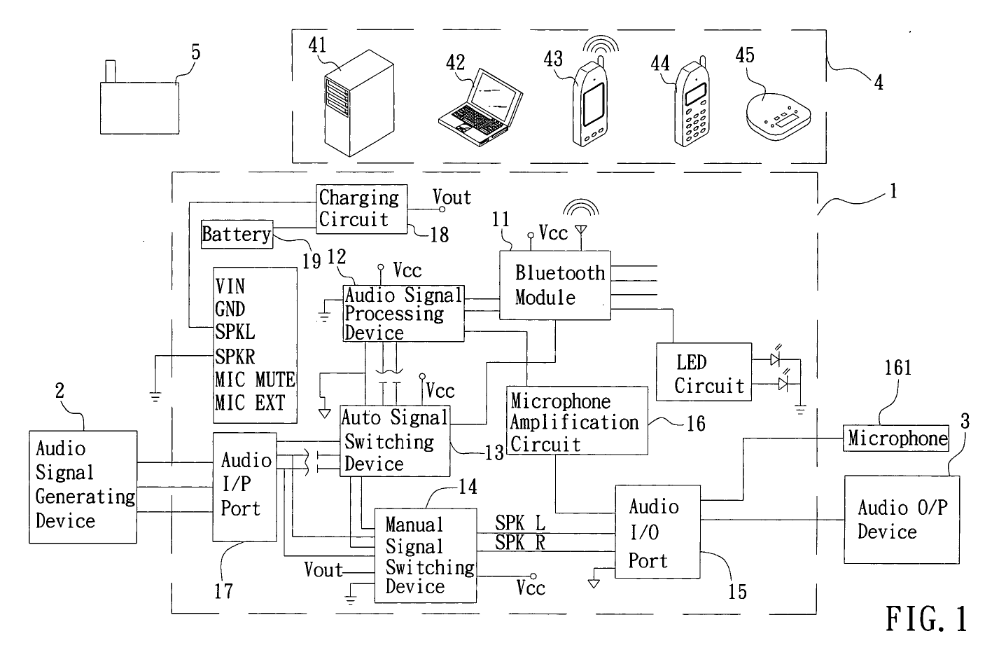

Please refer to FIG. 1, which is a functional block diagram showing an audio I/O device with a Bluetooth module according to the present invention. The audio I/O device 1 comprises: a Bluetooth module 11, an audio signal processing device 12, an automatic signal switching device 13, a manual signal switching device 14, an audio I/O port 15, a microphone amplification circuit 16 and an audio input port 17.

The Bluetooth module 11 with Bluetooth protocol, for example, Advanced Audio Distribution Profile (A2DP) and Headset/Hands-free Profile, is connected to the audio I/O port 15 so as to receive audio signals from an external microphone 161 through the microphone amplification circuit 16 and transmit/receive wireless audio signals according to wireless Bluetooth protocol. The Bluetooth module 11 receives the audio signals from a matched electronic product with A2DP profile and output to the audio signal processing device 12 (codec) so as to output analog audio signals. The analog audio signals are then transmitted to the automatic signal switching device 13 and the manual signal switching device 14 and are then outputted by the audio I/O port 15 to an audio output device 3 such as an earphone.

The audio I/O port 15 is connected to the audio output device 3 and receives audio signals from the microphone 161 so that the user receives audio signals from the matched electronic product 4 with Bluetooth protocol. The Bluetooth module 11 uses electricity stored in a rechargeable battery 19 (for example, a Ni-MH battery, a Li battery or a Li-polymer battery) recharged by a charging circuit 18 and installed in the audio I/O device 1. Otherwise, the Bluetooth module 11 with A2DP Profile or Headset/Hands-free Profile uses electricity from an external AC power supply.

The audio signal processing device (CODEC) 12 processes the audio signals from the external microphone 161 through the microphone amplification circuit 16 and the wireless audio signals from the electronic product 4 with wireless Bluetooth protocol. The audio signal processing device (CODEC) 12 is connected to the automatic signal switching device 13 and the manual signal switching device 14 so that the audio signals are outputted by the audio I/O port 15 to the audio output device 3 such as an earphone.

The automatic signal switching device 13 receives the audio signals from the external microphone 161 through the microphone amplification circuit 16 and the wireless audio signals from the electronic product 4 (such as a personal computer 41, a notebook computer 42, a personal digital assistant 43 and a mobile phone 44) with the wireless Bluetooth protocol. The automatic signal switching device 13 switches off the analog audio signals from the audio input port 17 after receiving the audio signals from the audio signal processing device 12 and switches on the audio signals from the audio signal processing device 12 into the manual signal switching device 14 and the audio I/O port 15.

The manual signal switching device 14 switches off the audio signals and the wireless audio signals from the audio signal processing device 12 through the automatic signal switching device 13 while switching on audio signals from an audio input port 17 connected to the manual signal switching device 13 so as to output through the audio I/O port 15 when the audio I/O device 1 runs out of electricity

The audio I/O port 15 connects to an audio output device 3 for audio output and the external microphone 161 for audio input.

The microphone amplification circuit 16 receives the audio signals from the external microphone 161 and is connected to the Bluetooth module 11 and the audio signal processing device 12 for full duplex processing so as to output to the electronic product 4.

The audio input port 17 receives analog audio signals from an audio signal generating device 2 (such as a stereo system, an MP3 player, a radio, a CD player, etc.) so as to output to the audio output device 3 through the audio I/O port 15.

More particularly, the audio signal generating device 2, the audio output device 3 and the audio I/O device 1 are connected to the electronic product 4 wirelessly. The electronic product 4 can be equipped with an internal wireless Bluetooth interface or be connected to a Bluetooth transmitter 5. The electronic product 4 without any internal wireless Bluetooth interface can be connected to a Bluetooth transmitter 5 so as to be connected to the Bluetooth module 11 wirelessly.

The Bluetooth transmitter 5 has a socket so as to receive the electronic product 4 without any internal wireless Bluetooth interface. Thus, the Bluetooth transmitter 5 receives the analog signals from the electronic product 4 without any internal wireless Bluetooth interface. The analog signals are coded into digital signals to be transmitted. The digital signals are received by the Bluetooth module 11 of the audio I/O device 1 and then are decoded by the audio signal processing device (CODEC) 12 into analog audio signals. The analog audio signals are then inputted into the automatic signal switching device 13, the manual signal switching device 14 and the audio I/O port 15 and then are outputted by the audio output device 3. Therefore, the user can enjoy music from the electronic product 4 without any internal Bluetooth interface but being connected to a Bluetooth transmitter 5.

The afore-mentioned Bluetooth transmitter is equipped with circuitry for audio signal processing according to A2DP profile. Therefore, the present invention provides an audio I/O device with a Bluetooth module that can be used to present high-quality music that is much better than monophonic music from conventional Bluetooth earphone.

According to the above discussion, the present invention discloses an audio I/O device with a Bluetooth module so that the user can not only receive phone calls from a mobile phone with a Bluetooth module but also listen to music from audio devices such MP3 players, CD players, etc. using the audio I/O device. Therefore, the present invention has been examined to be new, non-obvious and useful.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An audio I/O device with a Bluetooth module, comprising:
a Bluetooth module, connected to an audio I/O port so as to receive audio signals from an external microphone through a microphone amplification circuit and transmit/receive wireless audio signals according to wireless Bluetooth protocol;
an audio signal processing device, processing said audio signals from said external microphone through said microphone amplification circuit and said wireless audio signals from an electronic product with said wireless Bluetooth protocol;
an automatic signal switching device, receiving said audio signals from said external microphone through said microphone amplification circuit and said wireless audio signals from said electronic product with said wireless Bluetooth protocol;
a manual signal switching device, switching off said audio signals and said wireless audio signals from said audio signal processing device through said automatic signal switching device while switching on audio signals from an audio input port connected to said manual signal switching device so as to output through said audio I/O port when said audio I/O device runs out of electricity;
an audio I/O port, connected to an audio output device for audio output and said external microphone for audio input;
a microphone amplification circuit, receiving said audio signals from said external microphone and connected to said Bluetooth module and said audio signal processing device for full duplex processing as to output to said electronic product; and
an audio input port, receiving analog audio signals from an audio signal generating device so as to output to said audio output device through said audio I/O port;
wherein said audio signal generating device, said audio output device and said audio I/O device are connected to said electronic product wirelessly.

2. The audio I/O device as recited in claim 1, wherein said audio signal generating device is an MP3 player.

3. The audio I/O device as recited in claim 1, wherein said audio signal generating device is a radio.

4. The audio I/O device as recited in claim 1, wherein said audio signal generating device is a CD player.

5. The audio I/O device as recited in claim 1, wherein said audio signal generating device is a stereo system.

6. The audio I/O device as recited in claim 1, wherein said audio signal generating device is a personal computer (PC).

7. The audio I/O device as recited in claim 1, wherein said audio signal generating device is a notebook computer.

8. The audio I/O device as recited in claim 1, wherein said audio signal generating device is a personal digital assistant (PDA).

9. The audio I/O device as recited in claim 1, wherein said Bluetooth module receives said wireless audio signals from said electronic product with said Bluetooth protocol, said wireless audio signals being processed by said audio signal processing device so as to output analog audio signals into said automatic signal switching device and said manual signal switching device, said analog audio signals then being outputted by said audio I/O port to said audio output device.

10. The audio I/O device as recited in claim 1, wherein said audio signal processing device outputs to said automatic signal switching device and said manual signal switching device, said analog audio signals then being outputted by said audio I/O port to said audio output device.

11. The audio I/O device as recited in claim 1, wherein said automatic signal switching device switches off said analog audio signals from said audio input port after receiving said audio signals from said audio signal processing device and switches on said audio signals from said audio signal processing device into said manual signal switching device and said audio I/O port.

12. The audio I/O device as recited in claim 1, wherein said audio I/O port receives said audio signals from said microphone into said microphone amplification circuit, said audio signals being amplified and then being outputted into said Bluetooth module and said audio signal processing device for full duplex processing as to output to said electronic product.

13. The audio I/O device as recited in claim 1, wherein said Bluetooth module uses electricity from a battery recharged by a charging circuit.

14. The audio I/O device as recited in claim 13, wherein said battery is one selected from a group including a Ni-MH battery, a Li battery and a Li-polymer battery.
